(19) United States
(12) Patent Application Publication
(10) Pub. No.: US 2019/0250994 A1
(43) Pub. Date: Aug. 15, 2019

(54) BACKUP CONTROL METHOD AND BACKUP CONTROL SYSTEM

(71) Applicant: HITACHI, LTD., Tokyo (JP)

(72) Inventors: Hideo SAITO, Tokyo (JP); Takaki NAKAMURA, Tokyo (JP); Soichi TAKASHIGE, Tokyo (JP); Masakuni AGETSUMA, Tokyo (JP)

(73) Assignee: HITACHI, LTD., Tokyo (JP)

(21) Appl. No.: 16/119,087

(22) Filed: Aug. 31, 2018

(30) Foreign Application Priority Data
Feb. 9, 2018 (JP) 2018-022583

(51) Int. Cl. G06F 11/14; G06F 9/455

(52) U.S. Cl. CPC G06F 11/1458; G06F 9/45558; G06F 2009/45579; G06F 2009/45583; G06F 2201/815; G06F 2009/4557

(57) ABSTRACT

To reduce cumbersomeness in manually setting backup requirements per middleware. Not only one or more deployment requirements but also one or more first backup requirements are associated with a middleware deployment indication. In response to the indication, middleware deployment and backup setting are performed. The middleware deployment includes associating volumes (VOLs) the number of which complies with the one or more deployment requirements, with virtual machines (VMs) the number of which complies with the one or more deployment requirements. The backup setting includes associating two or more backup requirements based on the one or more first backup requirements and one or more predetermined second backup requirements in response to a middleware type of middleware to be deployed, with the middleware deployment.

### BACKGROUND OF THE INVENTION

### 1. Field of the Invention

The present invention generally relates to backup control.

### 2. Description of the Related Art

It is known that one or more virtual machines (VMs) can execute middleware. As regards the VM, a technique of US2015/0106809 is known. A method disclosed in US2015/0106809 includes storing an indication that a first system resource is associated with a first service level; storing an indication that a second system resource is associated with a second service level; during deployment of a virtual machine, determining that the virtual machine is associated with the first service level; and in response to the determining, deploying the virtual machine utilizing the first resource.

The deployed virtual machine executes middleware. While a function to acquire a backup of a volume (VOL) in which data from the middleware is stored may be one of functions owned by the middleware, the function is generally one of functions owned by a storage that provides the VOL. To acquire the backup by the function, it is necessary to manually set backup requirements in response to a middleware type. It is cumbersome to manually set the backup requirements per middleware.

### SUMMARY OF THE INVENTION

A backup control system receives a middleware deployment indication with which not only one or more deployment requirements that define the number of virtual machines executing middleware to be deployed and the number of volumes associated with the virtual machines but also one or more first backup requirements are associated; and in response to the indication, performing middleware deployment and backup setting. The middleware deployment includes associating the volumes the number of which complies with the one or more deployment requirements, with the virtual machines the number of which complies with the one or more deployment requirements and that execute the middleware to be deployed. The backup setting includes associating two or more backup requirements based on the one or more first backup requirements and one or more predetermined second backup requirements in response to a middleware type of middleware to be deployed, with the middleware deployment.

According to the present invention, it is possible to reduce the cumbersomeness of manually setting backup requirements per middleware.

### BRIEF DESCRIPTION OF THE DRAWINGS

FIG. 1 illustrates a configuration of a computing system according to one embodiment;

FIG. 2 illustrates a detailed configuration of the computing system;

FIG. 3 illustrates a first region in a storage section of a node;

FIG. 4 illustrates a second region in the storage section of the node;

FIG. 5 illustrates a third region in the storage section of the node;

FIG. 6 illustrates a configuration of a deployment rule table;

FIG. 7 illustrates a configuration of an instance management table;

FIG. 8 illustrates a flow of a deployment process;

FIG. 9 illustrates a flow of a parameter extraction process;

FIG. 10 illustrates a flow of a VOL creation process;

FIG. 11 illustrates a flow of a VM creation process;

FIG. 12 illustrates a flow of an instance registration process;

FIG. 13 illustrates a flow of a stop registration control process;

FIG. 14 illustrates a flow of a snapshot acquisition process; and

FIG. 15 illustrates a flow of a restore process.

### DESCRIPTION OF THE PREFERRED EMBODIMENTS

In the following description, an “interface section” may be one or more interfaces. The one or more interfaces may be one or more communication interface devices of the same type (for example, one or more network interface cards (NICs) or may be one or more communication interface devices of different types (for example, an NIC and/or a host bus adapter (HBA)).

Furthermore, in the following description, a “memory section” is one or more memories and typically a main storage device. At least one memory in the memory section may be either a volatile memory or a nonvolatile memory.

Moreover, in the following description, a “PDEV section” is one or more PDEVs and may be typically an auxiliary storage device. The “PDEV” means a physical storage device and is typically a nonvolatile storage device, for example, a hard disk drive (HDD) or a solid state drive (SSD).

Furthermore, in the following description, a “storage section” is at least one of the memory section and the PDEV section (typically, at least the memory section).

Further, in the following description, a “processor section” is one or more processors. At least one processor is typically a microprocessor such as a central processing unit (CPU) but may be the other type of processor such as a graphics processing unit (GPU). The at least one processor may be either a single core processor or a multicore processor. The at least one processor may be a processor in a broad sense such as a hardware circuit (for example, a field-programmable gate array (FPGA) or an application specific integrated circuit (ASIC) that performs part of or entirety of processes).

Moreover, in the following description, information is often described using an expression such as “xxx table”; however, the information may be expressed in any data structure. In other words, to indicate that information does not depend on a data structure, “xxx table” can be rephrased as “xxx information.” Further, in the following description, a configuration of each table is exemplary and one table may be divided into two or more tables and all of or part of the two or more tables may be one table.

Furthermore, in the following description, a process is often described with “program” used as a subject; however, the subject of the process may be the processor section (or a device such as a controller having such a processor section) since a specified process is performed using the memory section and/or the interface section as appropriate by executing the program by the processor section. The program may be installed into a device such as a computing machine from a program source. The program source may be, for example, a program distribution server or a computing machine-readable (for example, non-transitory) recording medium. Moreover, in the following description, two or more programs may be realized as one program or one program may be realized as two or more programs.

Furthermore, in the following description, “VOL” is an abbreviation of a volume (logical volume) and may be a logical storage device. The VOL may be a virtual VOL (VOL compliant with thin provisioning) or may be a substantive VOL based on a physical storage resource (for example, one or more RAID groups).

Further, in the following description, a “computing system” includes one or more physical computing machines. At least one physical computing machine may be a general-purpose computing machine. The at least one physical computing machine may execute a VM or a software-defined anything (SDx). Examples of the SDx that can be adopted include a software defined storage (SDS) and a software-defined datacenter (SDDC). For example, an identical physical computing machine may execute a VM serving as a compute device (for example, host) and a VM serving as a storage device (storage controller) that receives an input/output (I/O) request from the compute device and that performs a process in response to the I/O request. In addition, the computing system may have a redundant configuration group. A redundant configuration may be, for example, a configuration with a plurality of nodes based on Erasure Coding, redundant array of independent nodes (RAIN), an inter-node mirroring, or the like, or may be a configuration within a single node such as one or more redundant array of independent (or inexpensive) disk (RAID) groups configured with PDEV sections.

Moreover, in the following description, a “management device” may be a system configured with one or more physical computing machines (an example of a backup control system) or may be a virtual device executed by the system. The system may have an interface section, a storage section, and a processor section connected to the interface section and the storage section.

An embodiment of the present invention will be described hereinafter with reference to the drawings. It is noted that the present invention is not limited to the embodiment described hereinafter.

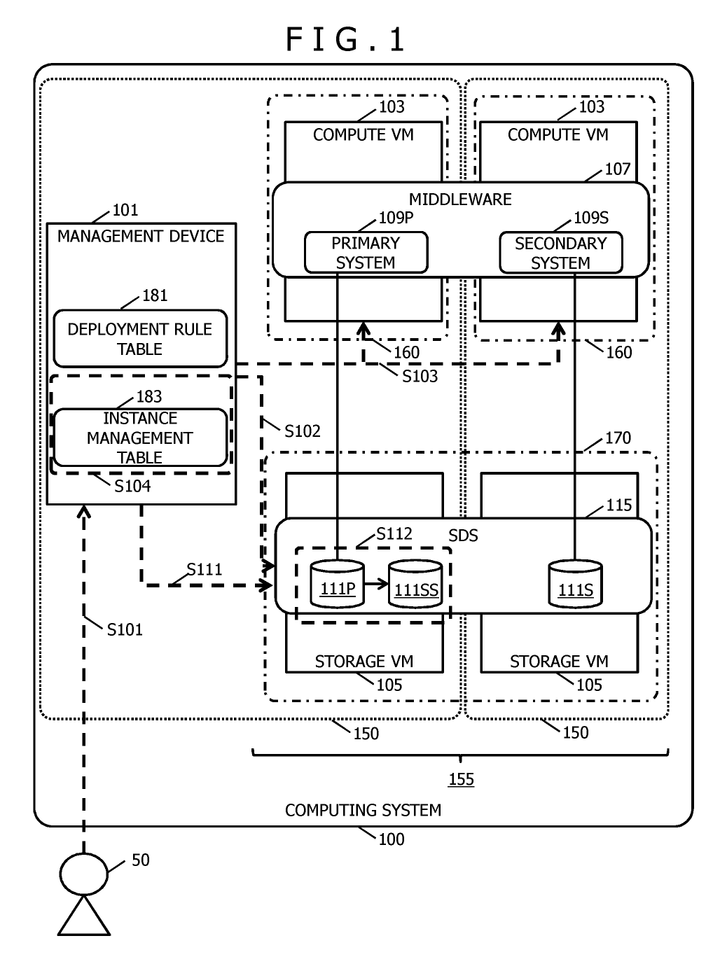

FIG. 1 illustrates a configuration of a computing system according to one embodiment.

A computing system 100 includes a middleware execution environment 155 and a management device 101.

The middleware execution environment 155 is an environment in which middleware is executed, that is, an execution environment of a VM that executes the middleware. The middleware execution environment 155 is based on a plurality of computer resources (for example, an interface section, a storage section, and a processor section). The middleware execution environment 155 executes one or more compute VMs 103 and one or more storage VMs 105. The compute VM 103 is a VM serving as a compute device. The storage VM 105 is a VM serving as a storage device. The storage VM 105 provides VOLs 111 (for example, a primary VOL (PVOL) 111P and a secondary VOL (SVOL) 111S) to the compute VM 103.

The management device 101 performs not only middleware deployment but also backup setting. The management device 101 may be either a physical computing machine or a VM. The management device 101 has a deployment rule table 181, and completes an instance management table 183 by the backup setting. The deployment rule table 181 stores information about deployment requirements and backup requirements per middleware type. The instance management table 183 retains information about instances (middleware deployment).

In the present embodiment, the following processes are, for example, performed.

The management device 101 receives, from, for example, an administrator 50, a middleware deployment indication with which not only one or more deployment requirements that define the number of compute VMs 103 executing middleware to be deployed 107 and the number of VOLs 111 associated with the compute VMs 103 but also one or more first backup requirements are associated (S101).

The management device 101 performs the middleware deployment (S102 and S103) and the backup setting (S104) in response to the indication.

The middleware deployment is performed, for example, as follows. The management device 101 causes the one or more storage VMs 105 to create the VOLs 111 the number of which complies with the one or more deployment requirements (S102). The management device 101 causes a hypervisor (not depicted) to create the compute VMs 103 (compute VM or VMs 103 executing middleware 107) the number of which complies with the one or more deployment requirements (S103). The management device 101 associates the VOLs 111 created in S102 with the compute VMs 103 created in S103.

The backup setting is performed, for example, as follows. The management device 101 associates two or more backup requirements based on the one or more first backup requirements and one or more predetermined second backup requirements (backup requirements registered in the deployment rule table 181) in response to a middleware type of the middleware 107 to be deployed, with an instance (registers the two or more backup requirements in entries corresponding to the instance in the instance management table 183) (S104).

In this way, according to the present embodiment, the management device 101 completes the instance management table 183 by registering the two or more backup requirements associated with the instance in the instance management table 183 at a time of the middleware deployment performed in response to the middleware deployment indication. Among the two or more backup requirements, part of the backup requirements are backup requirements (deployment requirements in response to the middleware type of the middleware 107) identified from the deployment rule table 181, and the two or more backup requirements based on the backup requirements identified from the deployment rule table 181 and the backup requirements associated with the middleware deployment indication are automatically set. The backup requirements retained in the deployment rule table 181 are requirements in the light of the middleware type of the middleware 107. It is thereby possible to automatically set the two or more backup requirements in response to the middleware type of the middleware 107 with respect to the VOLs that are associated with the middleware 107 (one or more compute VMs 103) in the middleware deployment, that is, to interlock the backup setting with the middleware deployment.

After the backup setting is automatically made as described above and a response to the middleware deployment indication is transmitted, the management device 101 indicates backup acquisition in compliance with the two or more automatically set backup requirements. It is assumed, for example, that the middleware 107 has a primary system 109P that uses the primary VOL (PVOL) 111P and a secondary system 109S that uses the secondary VOL (SVOL) 111S. The management device 101 transmits a backup acquisition indication to, for example, the storage VM 105 that provides the PVOL 111P in compliance with the two or more backup requirements that are associated with the instance of the middleware 107 and that are automatically set (S111). The storage VM 105 that has received the indication acquires a backup (for example, a snapshot VOL 111SS) of the PVOL 111S (S112). In this way, the management device 101 can indicate the backup acquisition on the basis of the automatically set backup requirements.

While the backup acquisition may be backup acquisition such as remote copying that is copying between the VOLs 111 provided by the different storage VMs 105, the backup acquisition is snapshot acquisition in the present embodiment. It is possible to automatically set backup requirements related to the snapshot acquisition as the deployment of the middleware 107 is performed.

The description given so far is an outline of the computing system 100 according to the present embodiment.

It is noted that various configurations can be adopted as the configuration of the computing system 100. For example, any of the following configurations (a) and (b) can be adopted as that of the computing system 100. In the present embodiment, the configuration (a) is adopted.

(a) As indicated by a chain line, the computing system 100 (at least the middleware execution environment 155) has a plurality of nodes (physical computing machines) 150. The nodes 150 are, for example, general-purpose computing machines. One node 150 executes the compute VM 103 and the storage VM 105. In addition, the node 150 may execute the VM serving as the management device 101. The VM 101 serving as the management device 101 may be executed by the node 150 other than the node 150 that executes the compute VM 103 and the storage VM 105.

(b) As indicated by a dot-and-dash line, the computing system 100 (at least the middleware execution environment 155) has one or more physical storage devices 170 and one or more physical compute devices 160 connected to the one or more physical storage devices 170. One or more compute VMs 103 are created in the one or more physical compute devices 160. The storage VM 105 may not be necessarily present in the storage device 170. In a case in which the storage VM 105 is not present in the storage device 170, the storage device 170 executes a similar process to that executed by the storage VM 105. An SDS 115 may be constructed by executing software having a storage function in at least one of the one or more physical storage devices 170.

The present embodiment will be described hereinafter in detail. While any of the middleware 107 and the storage (storage VM 105 (or SDS 115) in the present embodiment) may have a function of the snapshot acquisition, it is assumed that the storage VM 105 has the function in the present embodiment. Specifically, a snapshot program 402 (refer to FIG. 4) executed by the storage VM 105 is an example of the snapshot acquisition function.

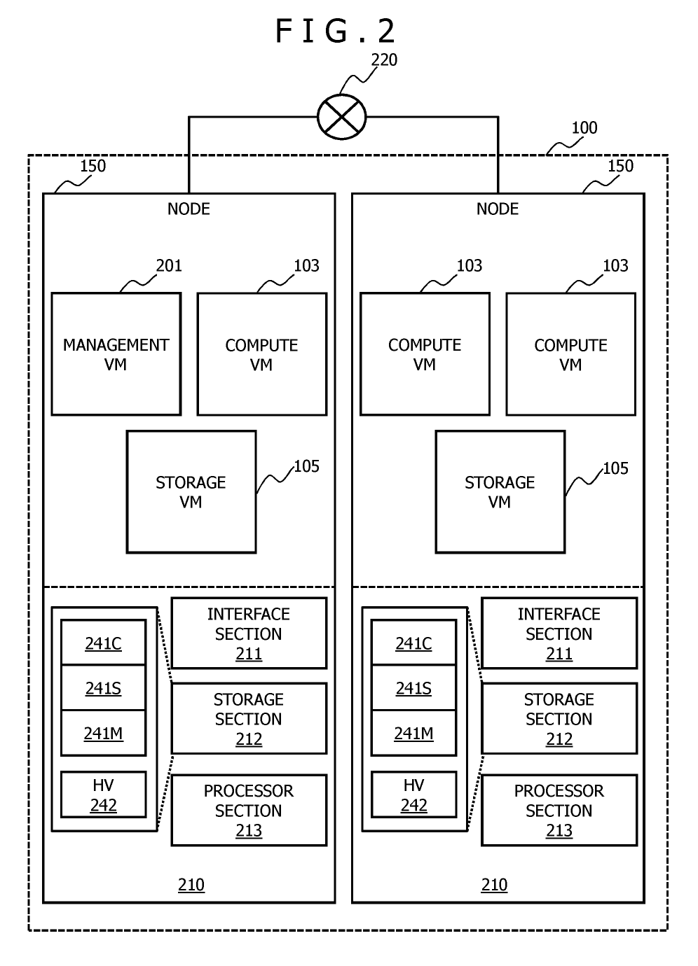

FIG. 2 illustrates a detailed configuration of the computing system 100. It is noted that in FIG. 2 and the following, the middleware (program) is often abbreviated as “MW,” an application (program) is often abbreviated as “AP,” a file system (program) is often abbreviated as “FS,” the hypervisor (program) is often abbreviated as “HV,” and snapshot is often abbreviated as “SS.”

The computing system 100 includes a plurality of nodes 150 connected to a network 220.

Each node 150 executes the compute VM 103 and the storage VM 105. In addition, a certain node 150 executes the management VM 201. The management VM 201 is the VM serving as the management device 101.

Each node 150 has physical resources 210. The node 150 executes the VMs on the basis of the physical resources 210. The physical resources 210 include an interface section 211 connected to the network 220, a storage section 212 that stores one or more programs, and a processor section 213 that is connected to the interface section 211 and the storage section 212 and that executes the programs within the storage section 212. The storage section 212 includes a first region 241C that is a storage region related to the compute VM 103 and a second region 241S that is a storage region related to the storage VM 105. The storage section 212 within the node 150 that executes the management VM 201 further includes a third region 241M that is a storage region related to the management VM 201. Furthermore, the storage section 212 stores a hypervisor 242 that crates or erases VMs.

In the present embodiment, the management VM 201 (computer program executed by the management VM 201) is executed by a computer. It is noted that the “computer” mentioned in this paragraph is any of the nodes 150 in the present embodiment and may be a computing machine connected to the middleware execution environment 155.

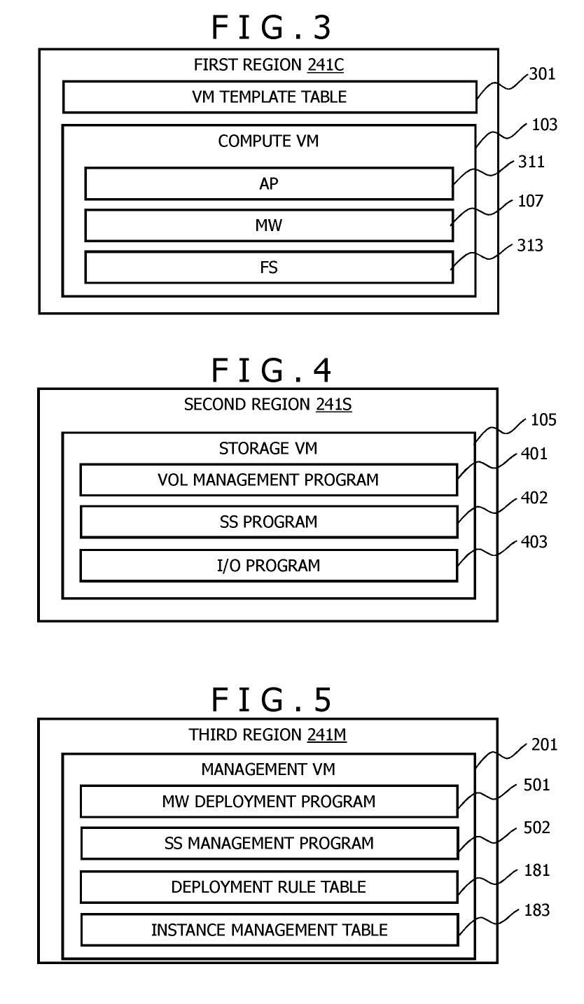

FIG. 3 illustrates the first region 241C.

The first region 241C stores a VM template table 301. The VM template table 301 manages a plurality of VM templates. The “VM template” indicates a template of a VM configuration such as the number of processors used by one VM and a memory capacity of the VM.

The compute VM 103 is executed on the basis of the first region 241C. The compute VM 103 executes programs that are, for example, an application 311, the middleware 107, and a file system 313.

FIG. 4 illustrates the second region 241S.

The storage VM 105 is executed on the basis of the second region 241S. The storage VM 105 executes, for example, a VOL management program 401 that provides the VOL 111, the snapshot program 402 that performs the snapshot acquisition, and an I/O program 403 that performs I/O in response to an I/O request.

FIG. 5 illustrates the third region 241M.

The third region 241M stores the deployment rule table 181 and the instance management table 183 described above.

The management VM 201 is executed on the basis of the third region 241M. The management VM 201 executes, for example, a middleware deployment program 501 that performs the middleware deployment and the backup setting described above and a snapshot management program 502 that indicates the snapshot acquisition.

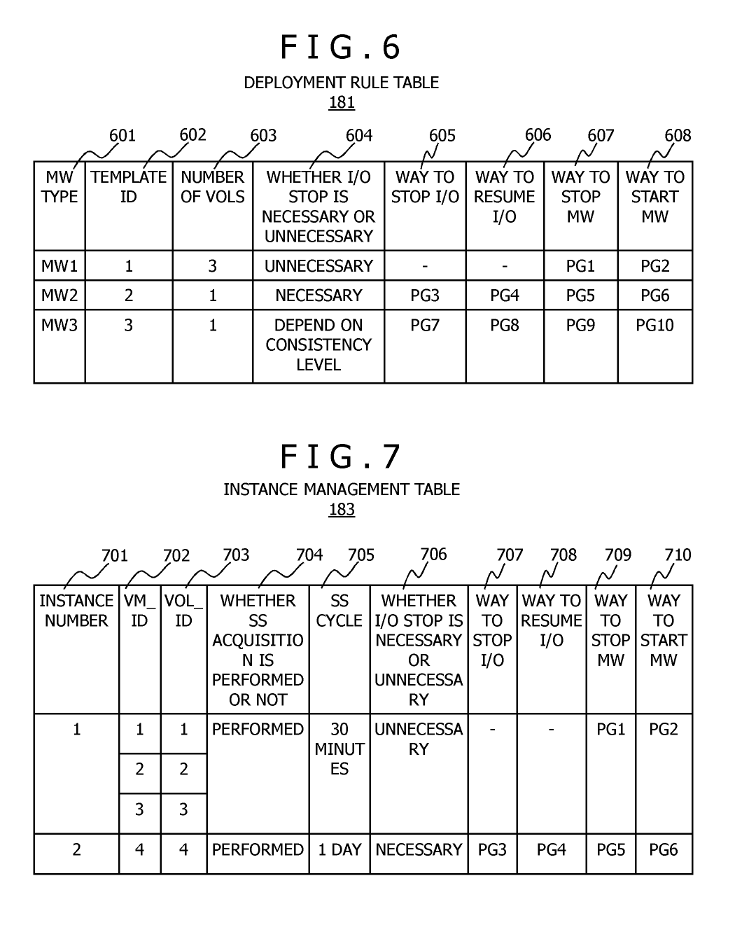

FIG. 6 illustrates a configuration of the deployment rule table 181. It is noted that the program is abbreviated as “PG” in FIGS. 6 and 7.

The deployment rule table 181 is a table that defines deployment requirements and backup requirements per middleware type. The deployment rule table 181 has entries per middleware type. The entries store, per middleware type, information such as a middleware type 601, a template ID 602, the number of VOLs 603, whether I/O stop is necessary or unnecessary 604, a way to stop I/O 605, a way to resume I/O 606, a way to stop middleware 607, and a way to start middleware 608. The information 602 and 603 is an example of the deployment requirements, the information 604 to 606 is an example of the backup requirements, and the information 607 and 608 is an example of restore requirements.

The middleware type 601 indicates a type of middleware. The template ID 602 indicates an ID of a VM template. The number of VOLs 603 indicates the number of VOLs. Whether I/O stop is necessary or unnecessary 604 indicates whether it is necessary or unnecessary to temporarily stop I/O. The way to stop I/O 605 is information effective in a case in which whether I/O stop is necessary or unnecessary indicates “necessary” or “depend on consistency level,” and indicates a way to temporarily stop I/O. The way to resume I/O 606 is information effective in a case in which whether I/O stop is necessary or unnecessary indicates “necessary” or “depend on consistency level,” and indicates a way to resume I/O. The way to stop middleware 607 indicates a way to stop middleware at a time of restoring the PVOL. The way to start middleware 608 indicates a way to start middleware stopped by the way indicated by the way to stop middleware 607. In the present embodiment, the ways 605 to 608 may be each defined in an arbitrary expression. For example, a program to be executed may be defined or a command may be defined. For example, as regards middleware 2, a program 3 is executed to temporarily stop I/O, a program 4 is executed to resume I/O, a program 5 is executed to stop the middleware 2 during restoring, and a program 6 is executed to start the middleware 2 after restoring.

The deployment rule table 181 may be determined in advance or at least part of the table 181 may be determined by the administrator 50.

FIG. 7 illustrates a configuration of the instance management table 183.

The instance management table 183 is a table that retains an instance result and backup requirements per instance. The instance management table 183 has entries per instance. The entries store, per type of instance, information such as an instance number 701, a VM_ID 702, a VOL_ID 703, whether snapshot acquisition is performed or not 704, a snapshot cycle 705, whether I/O stop is necessary or unnecessary 706, a way to stop I/O 707, a way to resume I/O 708, a way to stop middleware 709, and a way to start middleware 710. The information 701 to 703 is an example of the instance result, the information 704 to 708 is an example of the backup requirements, and the information 709 and 710 is an example of the restore requirements. It is noted that the “instance” means the middleware deployment as described above, and specifically includes not only deployed middleware but also all VMs that execute the middleware (for example, all VMs created at a time of the middleware deployment), and all VOLs associated with all the VMs.

The instance number 701 indicates an identification number of an instance. The VM_ID 702 indicates IDs of all the VMs included in the instance. The VOL_ID 703 indicates IDs of all the VOLs associated with all the VMs included in the instance. Whether snapshot acquisition is performed or not 704 indicates whether snapshot acquisition is performed with respect to the instance. The snapshot cycle 705 is information effective in a case in which whether snapshot acquisition is performed or not 704 indicates “performed,” and indicates a snapshot cycle (snapshot acquisition time interval). Whether I/O stop is necessary or unnecessary 706, the way to stop I/O 707, the way to resume I/O 708, the way to stop middleware 709, and the way to start middleware 710 are the same as whether I/O stop is necessary or unnecessary 604, the way to stop I/O 605, the way to resume I/O 606, the way to stop middleware 607, and the way to start middleware 608, respectively.

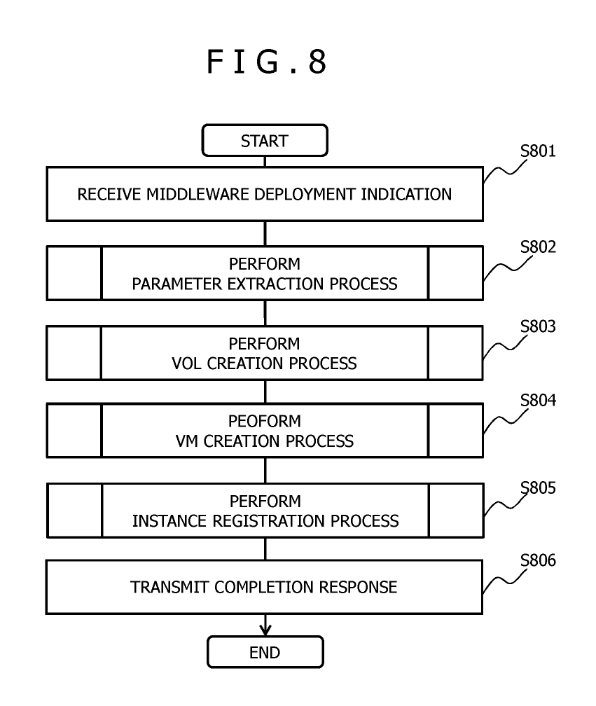

An example of processes performed in the present embodiment will be described hereinafter with reference to FIGS. 8 to 15. It is noted that the processes depicted in FIGS. 8 to 15 are executed by the management VM 201.

FIG. 8 illustrates a flow of an overall deployment process.

The middleware deployment program 501 receives a middleware deployment indication from, for example, the administrator 50 (S801). The middleware deployment indication defines, for example, the following parameters (p1) to (p5) as parameters.

(p1) The middleware type of middleware to be deployed,

(p2) The ID of the VM template (or the number of VMs and the resource amount (for example, the number of CPUs and the memory capacity) of each VM),

(p3) Whether snapshot acquisition is performed or not,

(p4) The snapshot acquisition cycle in a case in which whether snapshot acquisition is performed or not indicates “performed”), and

(p5) The consistency level in a case in which whether I/O stop is necessary or unnecessary corresponding to at least (p1) indicates “depend on consistency level.”

The parameters (p1) and (p2) are an example of the deployment requirements. The parameters (p3) to (p5) are an example of first backup requirements characteristic of the middleware deployment indication. The number of VOLs 603 identified from the deployment rule table 181 with (p1) as a key is an example of the deployment requirements. The number of VOLs may be defined in the VM template or may be associated with the middleware deployment indication as an alternative to being uniquely determined by the middleware type. The information 604 to 606 identified from the deployment rule table 181 with (p1) as a key is an example of second backup requirements. The information 607 and 608 identified from the deployment rule table 181 with (p1) as a key is an example of restore requirements.

The middleware deployment program 501 performs S802 to S805 in response to the middleware deployment indication.

In other words, the middleware deployment program 501 performs a parameter extraction process for extracting parameters designated in the middleware deployment indication and parameters (information) identified from the deployment rule table 181 with the parameter (p1) (middleware type) among these designated parameters as a key (S802).

The middleware deployment program 501 then performs the middleware deployment. Specifically, the middleware deployment program 501 performs a VOL creation process for causing one or more storage VMs 105 to create VOLs the number of which is equal to the calculated number of VOLs (S803). In addition, the middleware deployment program 501 performs a VM creation process for causing the hypervisor 242 to create VMs the number of which is equal to the number of VMs extracted in S802, and attaches (associates) the VOLs created in S803 to (with) the VMs (S804).

The middleware deployment program 501 performs an instance registration process including the backup setting for associating two or more backup requirements with an instance (S805).

After S802 to S805, the middleware deployment program 501 transmits a middleware deployment completion response to a source of the middleware deployment indication (S806).

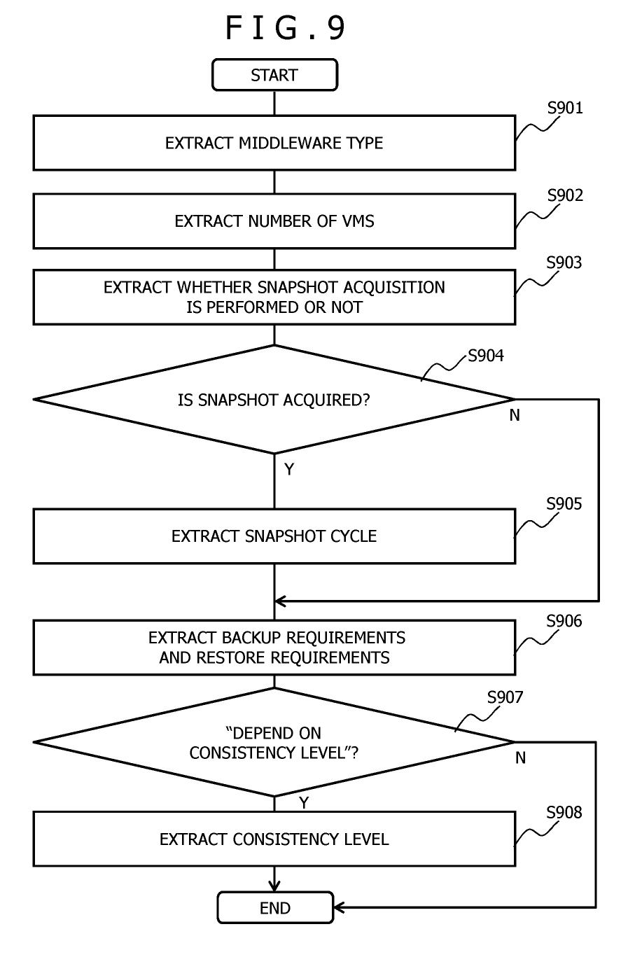

Description given so far is the flow of the overall deployment process. Details of the processes in the deployment process are illustrated in FIGS. 9 to 13.

FIG. 9 illustrates a flow of the parameter extraction process (S802 of FIG. 8).

The middleware deployment program 501 extracts the middleware type from the middleware deployment indication (S901).

The middleware deployment program 501 extracts the number of VMs (S902). Specifically, the middleware deployment program 501 identifies the VM template ID corresponding to the middleware type extracted in S901 from the deployment rule table 181. The middleware deployment program 501 identifies the VM template corresponding to the identified VM template ID from the VM template table 301. The middleware deployment program 501 identifies the number of VMs defined in the identified VM template.

The middleware deployment program 501 extracts whether snapshot acquisition is performed or not from the middleware deployment indication (S903).

In a case in which whether snapshot acquisition is performed or not extracted in S903 indicates “performed” (S904: Y), the middleware deployment program 501 extracts the snapshot cycle from the middleware deployment indication (S905).

The middleware deployment program 501 extracts the backup requirements (information 604 to 606) and the restore requirements (information 607 and 608) corresponding to the middleware type extracted in S901 (S906).

In a case in which whether I/O stop is necessary or unnecessary 604 extracted in S906 indicates “depend on consistency level” (S907: Y), the middleware deployment program 501 extracts the consistency level from the middleware deployment indication (S908).

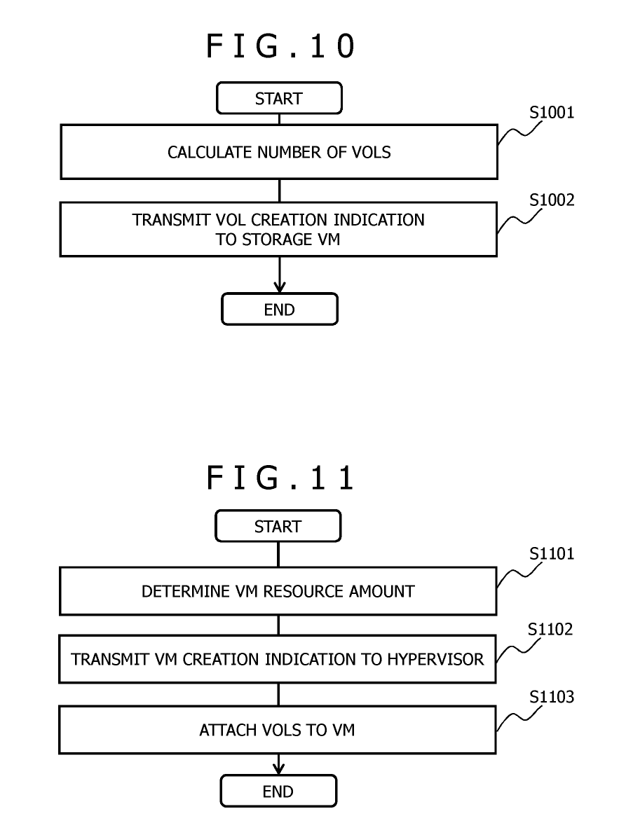

FIG. 10 illustrates a flow of the VOL creation process (S803 of FIG. 8)

The middleware deployment program 501 calculates the number of VOLs on the basis of the number of VOLs 603 corresponding to the middleware type extracted in S901 and the number of VMs extracted in S902 (S1001). The calculated number of VOLs may be equal to the number of VOLs 603 corresponding to the middleware type extracted in S901 or may be a product between the number of VOLs 603 and the number of VMs. The number of VOLs based on the number of VOLs 603 may be defined in the VM template corresponding to the middleware type extracted in S901.

The middleware deployment program 501 transmits a VOL creation indication to create VOLs the number of which is calculated in S1001 to the one or more storage VMs 105 (S1002). The one or more storage VMs 105 thereby create VOLs in accordance with the creation indication. A capacity of each created VOL may be defined in the VM template corresponding to the middleware type extracted in S901 or may be designated as one of the parameters in the middleware deployment indication.

FIG. 11 illustrates a flow of the VM creation process (S804 of FIG. 8).

The middleware deployment program 501 identifies the resource amount of each VM on the basis of the VM template corresponding to the middleware type extracted in S901 (S1101).

The middleware deployment program 501 transmits a VM creation indication to create the VMs the number of which is extracted in S802 and each of which has the resource amount identified in S1101 to the hypervisor 242 (S1102). The hypervisor 242 thereby creates VMs in accordance with the creation indication.

The middleware deployment program 501 attaches the VOLs created in S803 to the VMs created in response to the creation indication of S1102 (S1103). Specifically, for example, middleware deployment program 501 transmits, to the VMs created in response to the creation indication of S1102 (or hypervisor 242), an indication to mount the VOLs created in S803, and transmits, to the storage VMs 105 providing the VOLs created in S803, an indication to permit I/O to/from the VOLs from the VMs created in response to the creation indication of S1102.

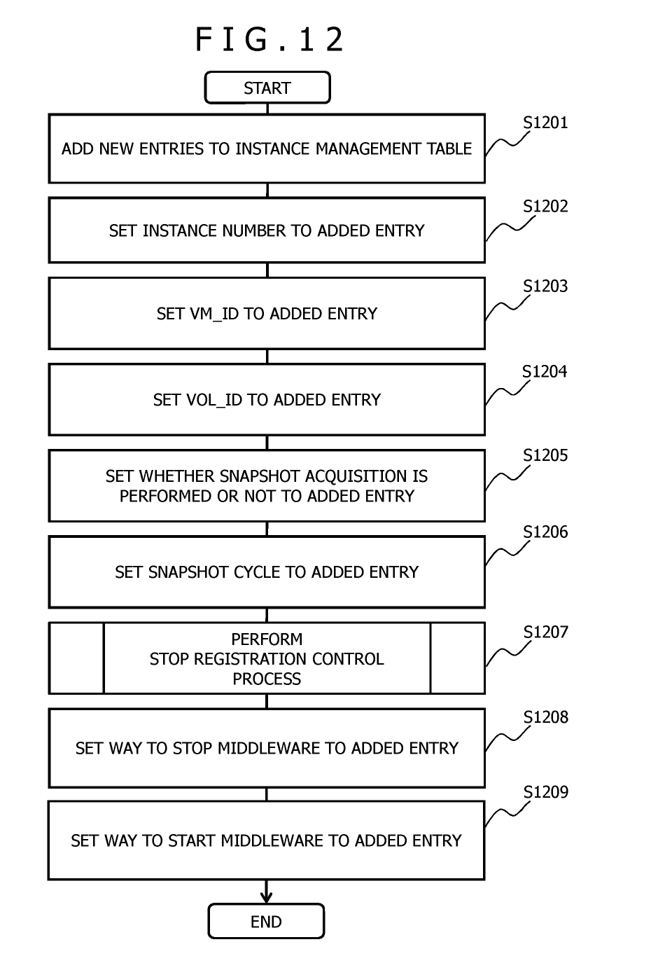

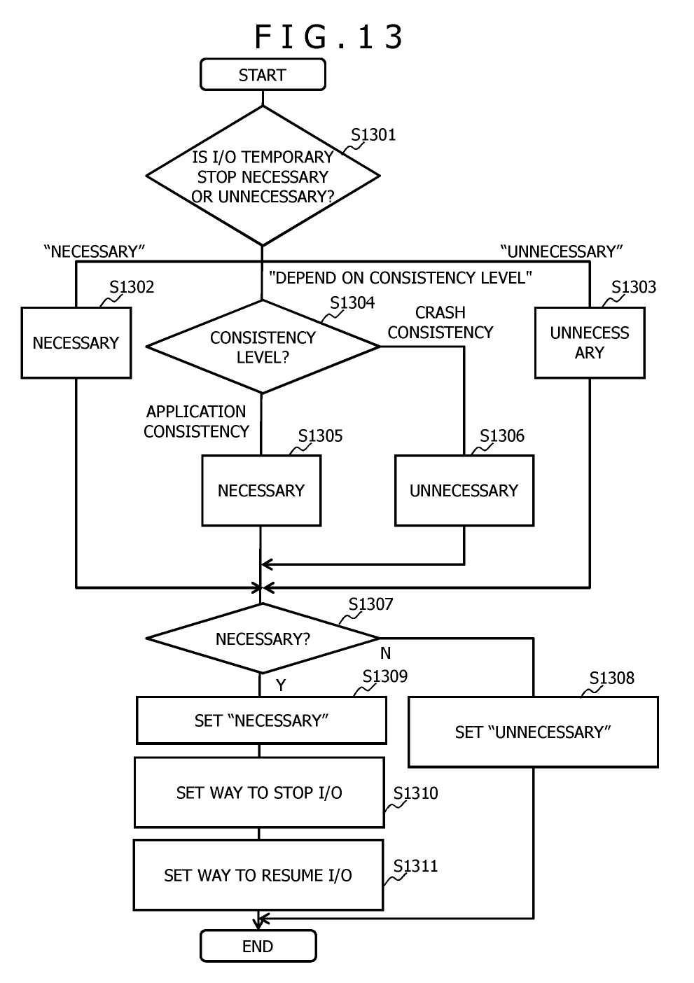

FIG. 12 illustrates a flow of the instance registration process (S805 of FIG. 8). S1205 to S1207 are an example of the backup setting. S1208 and S1209 are an example of restore setting.

The middleware deployment program 501 adds new entries to the instance management table 183 (S1201).

The middleware deployment program 501 sets an instance number (new instance number) corresponding to an instance of S803 and S804 to one of the new entries added in S1201 as the instance number 701 (S1202).

The middleware deployment program 501 sets the IDs of all the VMs created in S804 to one of the new entries added in S1201 as the VM_ID 702 (S1203).

The middleware deployment program 501 sets the IDs of all the VOLs created in S803 to one of the new entries added in S1201 as the VOL_ID 703 (S1204).

The middleware deployment program 501 sets whether snapshot acquisition is performed or not extracted in S903 to one of the new entries added in S1201 as whether snapshot acquisition is performed or not 704 (S1205).

The middleware deployment program 501 sets the snapshot cycle (an invalid value “-” in a case in which whether snapshot acquisition is performed or not indicates “not performed”) extracted in S905 to one of the new entries added in S1201 as the snapshot cycle 705 (S1206).

The middleware deployment program 501 performs a stop registration control process for determining a value related to temporary stop of I/O and setting the value to one of the new entries (new entries added in S1201) (S1207).

The middleware deployment program 501 sets the way to stop middleware extracted in S906 to one of the new entries added in S1201 as the way to stop middleware 709 (S1208).

The middleware deployment program 501 sets the way to start middleware extracted in S906 to one of the new entries added in S1201 as the way to start middleware 710 (S1209).

FIG. 13 illustrates a flow of the stop registration control process (S1207 of FIG. 12).

The middleware deployment program 501 determines whether I/O stop is necessary or unnecessary 604 extracted in S906 indicates any of “necessary,” “unnecessary,” and “depend on consistency level” (S1301).

In a case in which whether I/O stop is necessary or unnecessary 604 indicates “necessary,” the middleware deployment program 501 determines that it is “necessary” to temporarily stop I/O (S1302). In a case in which whether I/O stop is necessary or unnecessary 604 indicates “unnecessary,” the middleware deployment program 501 determines that it is “unnecessary” to temporarily stop I/O (S1303).

In a case in which whether I/O stop is necessary or unnecessary 604 indicates “depend on consistency level,” the middleware deployment program 501 determines whether the consistency level extracted in S908 is “application consistency” or “crash consistency” (S1304). In a case in which the consistency level extracted in S908 is “application consistency” (that is, data consistency at an application level is necessary), the middleware deployment program 501 determines that it is “necessary” to temporarily stop I/O (S1305). In a case in which the consistency level extracted in S908 is “crash consistency” (that is, data consistency at the application level is unnecessary), the middleware deployment program. 501 determines that it is “unnecessary” to temporarily stop I/O (S1306).

In a case of determining that it is “unnecessary” to temporarily stop I/O (S1307: N), the middleware deployment program 501 sets “unnecessary” for whether I/O stop is necessary or unnecessary 706 to one of the new entries added in S1201 (S1308).

In a case of determining that it is “necessary” to temporarily stop I/O (S1307: Y), the middleware deployment program 501 sets “necessary” for whether I/O stop is necessary or unnecessary 706 to one of the new entries added in S1201 (S1309), and further sets the way to stop I/O and the way to resume I/O extracted in S906 as the way to stop I/O 707 and the way to resume I/O 708, respectively (S1310 and S1311).

Description given so far is the details of the processes in the deployment process.

According to the description so far, the one or more backup requirements designated in the middleware deployment indication include whether snapshot acquisition is performed or not. In the case in which whether snapshot acquisition is performed or not indicates “performed,” the one or more backup requirements designated in the middleware deployment indication further include the snapshot cycle. The one or more backup requirements extracted with the middleware type designated in the middleware deployment indication as a key include whether I/O stop is necessary or unnecessary 604 (whether it is necessary or unnecessary to temporarily stop I/O to/from the VOLs). In addition, in the case in which whether I/O stop is necessary or unnecessary 604 indicates “necessary,” the backup requirements further include the way to stop I/O 605 and the way to resume I/O 606. In this way, according to the present embodiment, it is possible to perform the backup setting for collectively associating, with an instance, the backup requirements (first backup requirements such as administrator-desired requirements) designated in the middleware deployment indication, and the backup requirements (second backup requirements such as predetermined requirements suited for the middleware type) extracted from the deployment rule table 181 with the middleware type designated in the middleware deployment indication as a key.

Furthermore, according to the description so far, in the case in which whether I/O stop is necessary or unnecessary 604 indicates “depend on consistency level,” the consistency level is designated in the middleware deployment indication. A value of whether I/O stop is necessary or unnecessary 706 associated with the instance is determined depending on the designated consistency level. The source (for example, administrator 50) of the middleware deployment indication can thereby control whether or not it is necessary to temporarily stop I/O through the designated consistency level. Specifically, for example, in the case in which the consistency level is “application consistency,” consistency at the application level is necessary; thus, whether I/O stop is necessary or unnecessary 706 indicates “necessary.” In the case in which the consistency level is “crash consistency,” consistency at the application level is unnecessary; thus, whether I/O stop is necessary or unnecessary 706 indicates “unnecessary.”

Moreover, in the description so far, not only the backup setting but also restore setting for associating two or more restore requirements in response to the middleware type with an instance is performed. It is thereby possible to set the requirements in response to the middleware type at the time of the middleware deployment with respect to not only the snapshot acquisition but also restoring for restoring PVOLs in a generation corresponding to the snapshot.

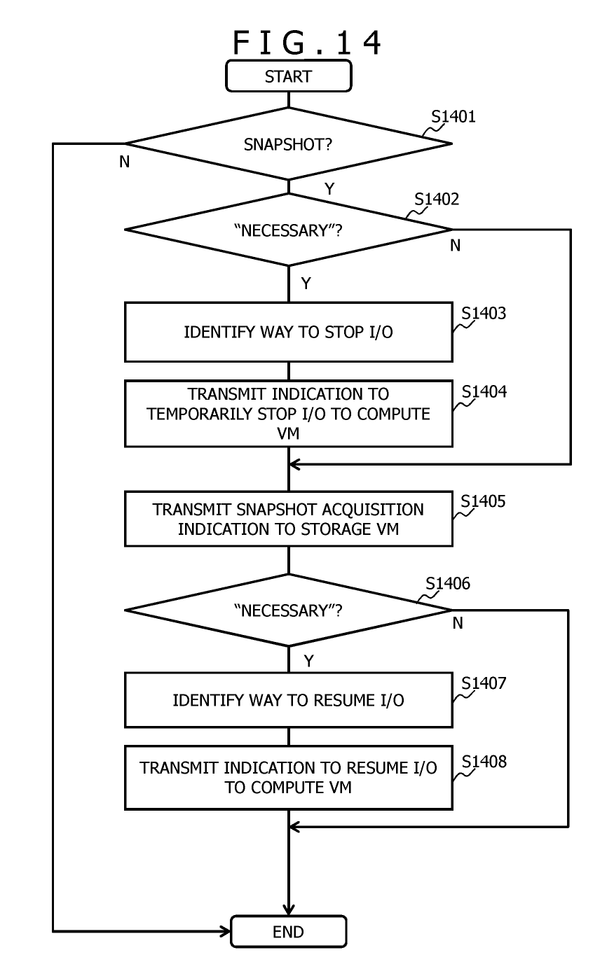

A snapshot acquisition process according to the backup setting performed in the deployment process illustrated in FIG. 8 is performed as illustrated in, for example, FIG. 14.

FIG. 14 illustrates a flow of the snapshot acquisition process. FIG. 14 illustrates the process with respect to a certain instance (“target instance” in description with reference to FIG. 14).

The snapshot management program 502 determines whether or not timing is snapshot acquisition timing (S1401). For example, in a case in which present time is time according to the snapshot cycle 705 corresponding to the target instance or a snapshot acquisition indication is received from the administrator 50, a determination result of S1401 is true. In a case in which the determination result of S1401 is false (S1401: N), the snapshot management program 502 ends the process.

In the case in which the determination result of S1401 is true (S1401: Y), the snapshot management program 502 determines whether I/O stop is necessary or unnecessary 706 corresponding to the target instance (S1402). In a case in which a determination result of S1402 is false (S1402: N), the process goes to S1405.

In a case in which the determination result of S1402 is true (S1402: Y), the snapshot management program 502 identifies the way to stop I/O 707 corresponding to the target instance (S1403), and transmits an indication to temporarily stop I/O by a way according to the identified way to stop I/O 707 to the compute VM 103 using the VOLs related to the target instance (S1404). The compute VM 103 that has received the indication thereby temporarily stops I/O by the way according to the way to stop I/O 707 identified in S1403.

After S1404 or in a case of S1402: N, the snapshot management program 502 transmits a snapshot acquisition indication including designation of PVOLs to the storage VM 105 providing the PVOLs (S1405). The snapshot program 402 in the storage VM 105 that has received the indication acquires snapshot of the PVOLs. In other words, in the snapshot acquisition process according to the backup setting, the storage VM 105 acquires the snapshot of the PVOLs by the snapshot program 402. Subsequently, in a case in which whether I/O stop is necessary or unnecessary 706 corresponding to the target instance indicates “necessary” (S1406: Y), the process goes to S1407. In a case in which whether I/O stop is necessary or unnecessary 706 corresponding to the target instance indicates “unnecessary” (S1406: N), the snapshot management program 502 ends the process.

In a case of S1406: Y, the snapshot management program 502 identifies the way to resume I/O 708 corresponding to the target instance (S1407), and transmits an indication to resume I/O by a way according to the identified way to resume I/O 708 to the compute VM 103 using the VOLs related to the target instance (S1408). The compute VM 103 that has received the indication resumes I/O by the way according to the way to resume I/O 708 identified in S1407.

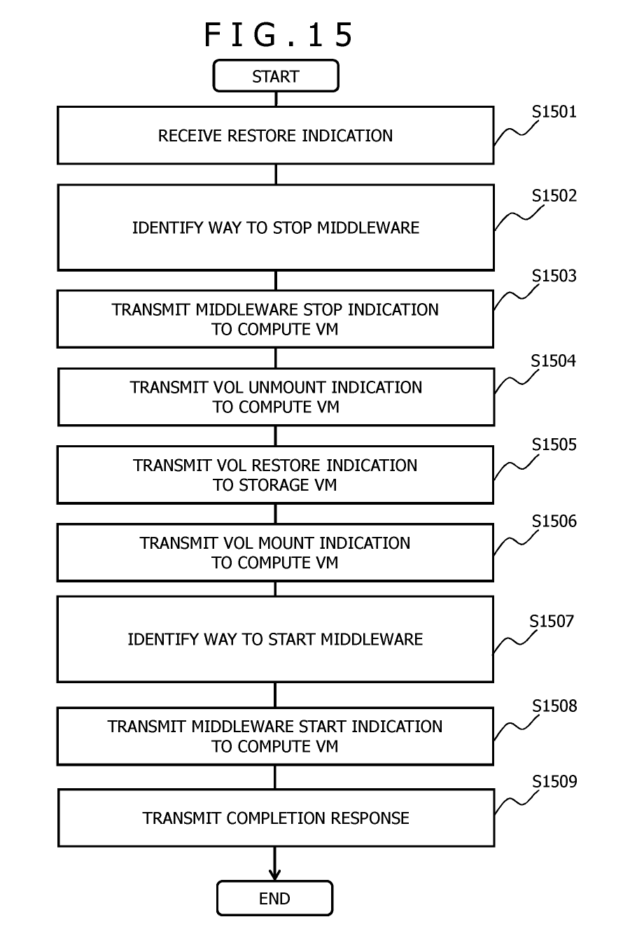

The restore process according to the restore setting performed in the deployment process illustrated in FIG. 8 is performed as illustrated in, for example, FIG. 15.

FIG. 15 illustrates a flow of the restore process. FIG. 15 illustrates the process with respect to a certain instance (“target instance” in description with reference to FIG. 15). It is noted that the snapshot management program 502 can also perform the restore process.

The snapshot management program 502 receives a restore indication from, for example, the administrator 50 (S1501). In the restore indication, a generation (for example, a snapshot number), for example, is designated.

The snapshot management program 502 identifies the way to stop middleware 709 corresponding to the target instance (S1502), and transmits an indication to stop the middleware by a way according to the identified way to stop middleware 709 to the compute VM 103 executing the middleware (S1503). The compute VM 103 that has received the indication stops the middleware by the way according to the way to stop middleware 709 identified in S1502.

The snapshot management program 502 transmits an indication to unmount the PVOLs provided to an application through the middleware, to the compute VM 103 executing the middleware corresponding to the target instance (S1504). The compute VM 103 that has received the indication unmounts the PVOLs designated in the indication.

The snapshot management program 502 transmits a restore indication using the snapshot to the storage VM 105 managing the snapshot corresponding to the designated generation (S1505). The storage VM 105 that has received the indication restores the PVOLs in the generation using the snapshot corresponding to the generation designated in the indication.

The snapshot management program 502 transmits an indication to mount the restored PVOLs to the compute VM 103 that is a destination of the unmount indication (S1506). The compute VM 103 that has received the indication mounts the PVOLs designated in the indication.

The snapshot management program 502 identifies the way to start middleware 710 corresponding to the target instance (S1507), and transmits an indication to start the middleware by a way according to the identified way to start middleware 710 to the compute VM 103 executing the middleware (S1508). The compute VM 103 that has received the indication starts the middleware by the way according to the way to start middleware 710 identified in S1507.

The snapshot management program 502 transmits a completion response to the restore indication of S1501 to a source of the restore indication (S1509).

While one embodiment of the present invention has been described, the description is exemplarily given for describing the present invention and does not intend to limit a scope of the present invention only to this embodiment. For example, the present invention is applicable to a backup other than the snapshot.

What is claimed is:

1. A backup control method comprising:
receiving a middleware deployment indication with which not only one or more deployment requirements that define the number of virtual machines executing middleware to be deployed and the number of volumes associated with the virtual machines but also one or more first backup requirements are associated; and
in response to the middleware deployment indication,
performing middleware deployment including associating the volumes the number of which complies with the one or more deployment requirements, with the virtual machines the number of which complies with the one or more deployment requirements and which execute the middleware to be deployed, and
performing backup setting including associating two or more backup requirements based on the one or more first backup requirements and one or more predetermined second backup requirements in response to a middleware type of the middleware to be deployed, with the middleware deployment.

2. The backup control method according to claim 1, wherein
the one or more first backup requirements include whether or not backup acquisition is performed,
the one or more first backup requirements include a backup acquisition cycle in a case in which the one or more first backup requirements include whether or not backup acquisition is performed indicating that the backup acquisition is present,
the one or more second backup requirements include whether it is necessary or unnecessary to temporarily stop input/output (I/O) to/from the volume, and
the one or more second backup requirements include a way to temporarily stop I/O and a way to resume I/O in a case in which the one or more second backup requirements include whether it is necessary or unnecessary to temporarily stop I/O to/from the volume indicating that it is necessary to temporarily stop I/O to/from the volume.

3. The backup control method according to claim 2, wherein
the one or more first backup requirements include a consistency level in a case in which whether it is necessary or unnecessary to temporarily stop I/O to/from the volume indicates depend on consistency level, and
whether it is necessary or unnecessary to temporarily stop I/O among the two or more backup requirements associated with the middleware deployment is determined in response to the consistency level included in the one or more first backup requirements in the backup setting.

4. The backup control method according to claim 3, wherein
whether it is necessary or unnecessary to temporarily stop I/O among the two or more backup requirements indicates that it is necessary to temporarily stop I/O in a case in which the consistency level in the one or more first backup requirements is application consistency, and
whether it is necessary or unnecessary to temporarily stop I/O among the two or more backup requirements indicates that it is unnecessary to temporarily stop I/O in a case in which the consistency level in the one or more first backup requirements is crash consistency.

5. The backup control method according to claim 3, wherein
the backup acquisition is snapshot acquisition.

6. The backup control method according to claim 1, comprising
in response to the middleware deployment indication, performing not only the backup setting but also restore setting for also associating two or more restore requirements in response to the middleware type of the middleware to be deployed with the middleware deployment.

7. The backup control method according to claim 1, comprising
after performing the backup setting and transmitting a response to the middleware deployment indication, indicating backup acquisition in compliance with the two or more backup requirements.

8. The backup control method according to claim 1, comprising
executing backup acquisition by a storage system in a backup acquisition process according to the backup setting.

9. A backup control system comprising:
an interface section that is one or more interfaces connected to a middleware execution environment that includes one or more computing machines executing a virtual machine that executes middleware to be deployed; and
a processor section that is one or more processors connected to the interface section, wherein
the processor section
receives a middleware deployment indication with which not only one or more deployment requirements that define the number of virtual machines executing middleware to be deployed and the number of volumes associated with the virtual machines but also one or more first backup requirements are associated; and
in response to the middleware deployment indication,
performs middleware deployment including associating the volumes the number of which complies with the one or more deployment requirements, with the virtual machines the number of which complies with the one or more deployment requirements and which execute the middleware to be deployed, and
performs backup setting including associating two or more backup requirements based on the one or more first backup requirements and one or more predetermined second backup requirements in response to a middleware type of the middleware to be deployed, with the middleware deployment.

10. A computer program, causing a computer to execute:
receiving a middleware deployment indication with which not only one or more deployment requirements that define the number of virtual machines executing middleware to be deployed and the number of volumes associated with the virtual machines but also one or more first backup requirements are associated; and
in response to the middleware deployment indication,
performing middleware deployment including associating the volumes the number of which complies with the one or more deployment requirements, with the virtual machines the number of which complies with the one or more deployment requirements and which execute the middleware to be deployed, and
performing backup setting including associating two or more backup requirements based on the one or more first backup requirements and one or more predetermined second backup requirements in response to a middleware type of the middleware to be deployed, with the middleware deployment.
